(19) United States
(12) Patent Application Publication
(10) Pub. No.: US 2012/0236301 A1
(43) Pub. Date: Sep. 20, 2012

(54) MEASUREMENT APPARATUS AND MEASUREMENT METHOD

(75) Inventor: Nobuaki HASHIMOTO, Suwa (JP)

(73) Assignee: SEIKO EPSON CORPORATION, Tokyo (JP)

(21) Appl. No.: 13/416,276

(22) Filed: Mar. 9, 2012

(30) Foreign Application Priority Data
Mar. 18, 2011 (JP) 2011-061225

(51) Int. Cl. G01J 3/44

(52) U.S. Cl. 356/301

(57) ABSTRACT

A measurement apparatus for measuring the concentration of a target substance contained in a sample includes: a light source (light source device); a light-incident body (sensor chip) that has a sample contact surface, where an enhanced electric field is formed by metal particles, and enhances Raman scattering light radiated from the target substance by light emitted from the light source in the enhanced electric field; an irradiation unit that causes the light emitted from the light source to enter into a plurality of areas in the light-incident body; a light-receiving unit (light-receiving element) that receives the Raman scattering light radiated from a plurality of the areas; and a quantitative measurement unit (control device) that quantitatively measures a concentration of the target substance based on a total number of the areas and a strength of the Raman scattering light received from the areas.

### BACKGROUND

1. Technical Field

The present invention relates to a measurement apparatus and measurement method. Particularly, the invention relates to a measurement apparatus and measurement method for detecting Raman scattering light generated when light is incident to a target substance included in a sample and measuring a concentration of the target substance in the sample.

2. Related Art

In the related art, there is known a Raman spectrometer in which substances are identified based on a fingerprint spectrum obtained from the Raman scattering light radiated from substances contained in the sample. However, since such Raman scattering light is weak, it may be difficult to appropriately obtain the fingerprint spectrum.

In this regard, there is known a Raman spectrometer (handheld Raman device) by which an enhanced electric field is formed to enhance the Raman scattering light, and the enhanced Raman scattering light is received (for example, refer to JP-T-2008-529006).

In the Raman spectrometer disclosed in JP-T-2008-529006, the enhanced electric field is formed by localized surface plasmon resonance (LSPR) by irradiating laser light onto the metal surface using a test strip having a substrate having a roughened metal surface and/or a substrate where surface enhanced Raman scattering (SERS) active metal particles and the like are coated. In addition, in the Raman spectrometer, a detection sensitivity of the Raman scattering light is improved by making contact between the analysis target sample and a metal surface and enhancing the Raman scattering light radiated from the substance invading into the enhanced electric field.

In the Raman spectrometer disclosed in JP-T-2008-529006 described above, a qualitative analysis for analyzing whether or not there is a substance contained in the sample can be made, but it is difficult to perform a quantitative analysis of the substance. Particularly, it is very difficult to perform the quantitative analysis of the substance under a concentration area where a significantly small amount of substances of about several molecules exists in the enhanced electric field formation area.

That is, in the enhanced electric field described above, the strength of the electric field is different in each portion. For this reason, for example, the strength of the Raman scattering light obtained when a single molecule of the substance invades into a portion where the strength of the electric field is high may be different from the strength of the Raman scattering light obtained when a single molecule of the substance invades into a portion where the strength of the electric field is low. As such, since the strength of the detected Raman scattering light is not proportional to the concentration of the substance, the quantitative analysis for measuring the concentration of the substance may not be performed even when the sufficient strength of the Raman scattering light is obtained.

For this reason, it is desirable to provide a measurement apparatus capable of performing the quantitative analysis of the substance contained in the sample.

### SUMMARY

An advantage of some aspects of the invention is to provide a measurement apparatus and a measurement method capable of measuring a concentration of a substance contained in a sample.

An aspect of the invention is directed to a measurement apparatus for measuring a concentration of a target substance contained in a sample, the measurement apparatus including: a light source; a light-incident body that has a sample contact surface, where an enhanced electric field is formed by metal particles, and enhances Raman scattering light radiated from the target substance by light emitted from the light source in the enhanced electric field; an irradiation unit that causes the light emitted from the light source to enter into a plurality of areas in the light-incident body; a light-receiving unit that receives the Raman scattering light radiated from a plurality of the areas; and a quantitative measurement unit that quantitatively measures a concentration of the target substance based on a total number of the areas and a strength of the Raman scattering light received from the areas.

A gaseous sample or a liquid sample may be used as the sample.

In addition, the sample contact surface of the light-incident body may have a plurality of convex portions coated by, for example, metal particles. A dimension between the convex portions may be preferably set to several nanometers to several tens of nanometers. The metal particles that coat each convex portion are preferably SERS active metal particles (such as gold, silver, copper, aluminum, palladium, and platinum) having a molecular diameter shorter than the wavelength of the light emitted from the light source. As a result, the enhanced electric field is formed between the convex portions, so that the Raman scattering light radiated from the target substance invading into the enhanced electric field is enhanced by the surface enhanced Raman scattering. Therefore, it is possible to improve a detection sensitivity of the Raman scattering light using the light-receiving unit.

In addition, it is preferable that the light source have a single wavelength such as a surface-emitting laser and emit linearly polarized light. Furthermore, it is preferable that the light source be alight source that emits light having a wavelength corresponding to a concentration measurement target substance.

Here, the target substances are stochastically distributed in the sample in proportion to the concentration. Therefore, as the concentration of the target substance increases (as the number of molecules increases) in the area where the light is irradiated and the enhanced electric field is generated, the number of areas where the Raman scattering light is emitted increases, and as a result, the strength of the Raman scattering light radiated from each area increases. However, as described above, the detected strength of the Raman scattering light is not directly proportional to the concentration of the target substance.

For this reason, according to the aspect of the invention, in the area of the significantly small concentration in which the number of molecules of the target substance corresponds to the number of areas where the light is irradiated, for example, by counting the number of areas, where the Raman scattering light of the target substance is received, out of a plurality of areas using the quantitative measurement unit, the number of areas becomes a value indicating a ratio of the areas having the target substance to the total number of areas, and a value indicating a distribution ratio of the target substance in the sample. In addition, it is possible to (quantitatively) measure the concentration of the target substance in the sample by obtaining the concentration corresponding to the counted number of the areas from the data obtained by measuring in advance a relationship between the number of areas and the concentration of the target substance.

For example, if the quantitative measurement unit computes a total sum of the strengths of the Raman scattering light received from a plurality of areas, the total sum of the strengths becomes a value indicating a distribution ratio of the target substance when the maximum Raman scattering light of the target substance is received from all of the areas. In addition, it is possible to measure (quantitatively) the concentration of a target substance in the sample by obtaining the concentration corresponding to the computed total sum of the strengths from the data measured in advance regarding a relationship between the total sum of the strengths and the concentration of the target substance.

It is preferable that the measurement apparatus further includes a storage unit that stores the number of areas, where the Raman scattering light of the target substance is received, out of a plurality of the areas and the concentration of the target substance measured in advance depending on the number of areas in relation to each other, wherein the quantitative measurement unit has a count unit that counts the number of areas, where the Raman scattering light of the target substance is received by the light-receiving unit, out of a plurality of the areas, and a concentration procurement unit that obtains the concentration of the target substance corresponding to the number of areas counted by the count unit from the storage unit.

Here, as described above, as the concentration of the target substance in the sample increases, the number of areas where the Raman scattering light is received increases.

In comparison, according to the aspect of the invention, the count unit counts the number of areas where the Raman scattering light of the target substance is received out of a plurality of areas. As a result, as described above, the counted number of areas indicates a ratio between the total number of areas and the number of areas where the Raman scattering light of the target substance is received. This ratio is a value indirectly indicating an averaged distribution ratio of the target substance. In addition, it is possible to obtain the concentration of the target substance by obtaining the concentration corresponding to the number of areas from the storage unit using the concentration procurement unit. Therefore, it is possible to measure the concentration of the target substance contained in the sample.

It is preferable that the measurement apparatus further includes a storage unit that stores a total sum of strengths of the Raman scattering light of the target substance received from a plurality of the areas and a concentration of the target substance corresponding to the total sum of the strengths in relation to each other, wherein the quantitative measurement unit has a total sum computation unit that computes a total sum of strengths of the Raman scattering light of the target substance received by the light-receiving unit from a plurality of the areas, and a concentration procurement unit that obtains the concentration of the target substance corresponding to the computed total sum of the strengths from the storage unit.

Here, as described above, as the concentration of the target substance increases, a total sum of the strengths of the Raman scattering light radiated from each area increases.

In this regard, according to the aspect of the invention, the total sum computation unit computes the total sum of the strengths of the Raman scattering light received by the light-receiving unit from each area. As a result, the computed total sum of the strengths indicates a ratio with respect to the maximum strength of the Raman scattering light received from all of the areas. This ratio is a value indirectly indicating an averaged distribution ratio of the target substance. In addition, it is possible to obtain the concentration of the target substance by obtaining the concentration corresponding to the computed total sum of the strengths from the storage unit using the concentration procurement unit. Therefore, it is possible to measure the concentration of the target substance contained in the sample.

It is preferable that the irradiation unit splits the light emitted from the light source into a plurality of light beams, and a plurality of the light beams be incident to each of the areas.

According to the aspect of the invention, the light emitted from the light source can be incident to a plurality of areas in the light-incident body at a single time. Therefore, in comparison with a case where light is individually incident to each area, it is possible to reduce the time for receiving the Raman scattering light from each area. Therefore, it is possible to measure the concentration of the target substance within a short time.

It is preferable that the irradiation unit causes the light emitted from the light source to enter into each of the areas in a time-division manner.

Here, in a case where the split partial light beams are incident to the light-incident body (sample contact surface), a deviation in the strength between each partial light beam may easily occur, and the strength of the light incident to each area may be reduced in comparison with the strength obtained before the splitting.

In comparison, according to the aspect of the invention, the light emitted from the light source is incident to each area of the light-incident body without being split into a plurality of light beams. Therefore, a problem relating to the deviation described above does not occur, and it is possible to prevent reduction of the strength of the light incident to each area. As a result, it is possible to increase the strength of the enhanced electric field. Therefore, in comparison with a case where the split light beams are incident to each area, it is possible to generate the Raman scattering light having a high strength and improve the light-receiving precision of the light-receiving unit.

It is preferable that the irradiation unit has a reflection unit that reflects the light emitted from the light source, and an adjustment unit that adjusts an angle between the reflection unit and a center axis of the light emitted from the light source to cause the light reflected by the reflection unit to enter into each of the areas.

In addition, the reflection unit may include a half mirror that reflects the light emitted from the light source, guides the light into the light-incident body, transmits the Raman scattering light radiated from each area, and guides the Raman scattering light into the light-receiving unit. The adjustment unit may include a stepping motor that can easily adjust the angle of the reflection unit.

Here, it is preferable that the light-incident body be arranged in the middle of the flow path of the sample formed in the guide unit such as a pipe in order to facilitate invasion of the substance into the enhanced electric field described above. For this reason, in a configuration in which the light-incident body is moved to cause the light emitted from the light source to enter into each area, it is necessary to provide a member for burying a gap between the light-incident body and the guide unit after the movement in order not to externally expose the passing sample, or it is necessary to move the guide unit along with the light-incident body. Therefore, the configuration of the measurement apparatus becomes complicated.

In comparison, according to the aspect of the invention, the light emitted from the light source is reflected by the reflection unit of which an angle with respect to the center axis of the light is adjusted by the adjustment unit and is incident to each area of the light-incident body. Therefore, in comparison with a case where the light-incident body is moved, it is possible to suppress the configuration of the measurement apparatus from being complicated and reliably receive the Raman scattering light radiated from each area.

If the half mirror described above is used as the reflection unit, it is not necessary to separately provide the reflection unit for reflecting the light emitted from the light source to each area. For this reason, it is possible to divert the configuration of the measurement apparatus employed in such a half mirror. In addition, since the path of the light emitted from the light source is separated from the path of the Raman scattering light received by the light-receiving unit, it is possible to improve a detection sensitivity of the Raman scattering light in the light-receiving unit.

It is preferable that the irradiation unit has a light-incident body movement unit that moves a light-incident body in a direction intersecting with a center axis of the light incident to the light-incident body, and a control unit that controls the light-incident body movement unit such that the light is incident to each of the areas.

Here, in the configuration for reflecting the light incident from the light source and causing the light to enter into each area, the incidence angle of the light incident to each area is changed in each area. For this reason, the polarization angle of the light is changed in the position of the area, and a difference in the light-receiving of the Raman scattering light generated in each area is easily generated.

In comparison, according to the aspect of the invention, the light-incident body is moved by the light-incident body movement unit under control of the control unit. Therefore, it is possible to cause the light to enter from the light source to each area with a constant angle with respect to the sample contact surface. Therefore, since it is possible to prevent a difference in the light-receiving of the Raman scattering light generated in each area, it is possible to improve reliability of the measured concentration.

Since the center axis of the light incident to the sample contact surface can be easily directed perpendicularly to the sample contact surface, it is possible to stabilize the light-receiving of the Raman scattering light.

It is preferable that the irradiation unit have a light source movement unit that moves the light source, and a control unit that controls the light source movement unit such that the light emitted from the light source moved by the light source movement unit is incident to each of the areas.

The movement of the light source using the light source movement unit may be translation in a direction perpendicular to the center axis of the light emitted from the light source before movement or rotation with respect to the rotation axis along the perpendicular direction.

According to the aspect of the invention, the light source movement unit moves the light source under control of the control unit such that the light emitted from the light source is incident to each area. As a result, similarly to the case where the reflection unit is moved as described above, it is possible to reliably cause the light to enter into each area without moving the light-incident body. Therefore, it is possible to suppress the configuration of the measurement apparatus from being complicated.

Another aspect of the invention is directed to a method of measuring a concentration of a target substance contained in a sample, the method including: causing light to enter into a plurality of areas of which a total number is set in advance on a sample contact surface, where an enhanced electric field is formed by metal particles, and enhancing Raman scattering light radiated from the target substance using the light under the enhanced electric field; receiving the Raman scattering light radiated from a plurality of the areas; and quantitatively measuring a concentration of the target substance based on a total number of the areas and a strength of the Raman scattering light received from each of the areas.

According to the aspects of the invention, similar to the aforementioned measurement apparatus, it is possible to measure the concentration of the target substance.

That is, for example, in the quantitative measurement, if the number of areas where the Raman scattering light of the target substance is received is counted out of a plurality of areas, the number of areas becomes a value indicating a ratio of the areas, where the target substance exists, with respect to the total number of areas, and a value indicating a distribution ratio of the target substance in the sample. It is possible to (quantitatively) measure the concentration of the substance in the sample by obtaining the concentration corresponding to the counted number of areas from the data obtained by measuring a relationship between the number of areas and the concentration of the substance in advance.

For example, in the quantitative measurement, if a total sum of the strengths of the Raman scattering light received from a plurality of areas is computed, the total sum of the strengths becomes a value indicating a distribution ratio of the target substance in comparison with a case where the maximum Raman scattering light of the target substance is received from all of the areas. It is possible to measure (quantitatively) the concentration of the substance in the sample by obtaining the concentration corresponding to the computed total sum of the strengths from the data obtained by measuring a relationship between the concentration of the substance and the total sum of the strengths in advance.

### BRIEF DESCRIPTION OF THE DRAWINGS

The invention will be described with reference to the accompanying drawings, wherein like numbers reference like elements.

FIG. 1 is a schematic diagram illustrating a configuration of the measurement apparatus according to a first embodiment of the invention.

FIG. 2 is a cross-sectional view schematically illustrating a sensor chip according to the aforementioned embodiment.

FIG. 3 is a plan view illustrating a sample contact surface of the sensor chip according to the aforementioned embodiment.

FIG. 4 is a schematic diagram illustrating an enhanced electric field formed on the sample contact surface according to the aforementioned embodiment.

FIG. 5 is a block diagram illustrating a configuration of the apparatus mainframe according to the aforementioned embodiment.

FIG. 6 is a diagram illustrating an exemplary captured image according to the aforementioned embodiment.

FIG. 7 is a flowchart illustrating a concentration measurement process according to the aforementioned embodiment.

FIG. 8 is a block diagram illustrating a configuration of the measurement apparatus according to a second embodiment of the invention.

FIG. 9 is a flowchart illustrating a concentration measurement process according to the aforementioned embodiment.

FIG. 10 is a schematic diagram illustrating a configuration of the measurement apparatus according to a third embodiment of the invention.

FIG. 11 is a block diagram illustrating a configuration of an apparatus mainframe of the measurement apparatus according to the aforementioned embodiment.

FIG. 12 is a diagram illustrating a movement direction of the area, where the light is incident, according to the aforementioned embodiment.

FIG. 13 is a flowchart illustrating a concentration measurement process according to the aforementioned embodiment.

FIG. 14 is a block diagram illustrating a configuration of the apparatus mainframe of the measurement apparatus according to a fourth embodiment of the invention.

FIG. 15 is a flowchart illustrating a concentration measurement process according to the aforementioned embodiment.

### DESCRIPTION OF EXEMPLARY EMBODIMENTS

### First Embodiment

Hereinafter, the first embodiment of the invention will be described with reference to the accompanying drawings.

### Entire Configuration of Measurement Apparatus

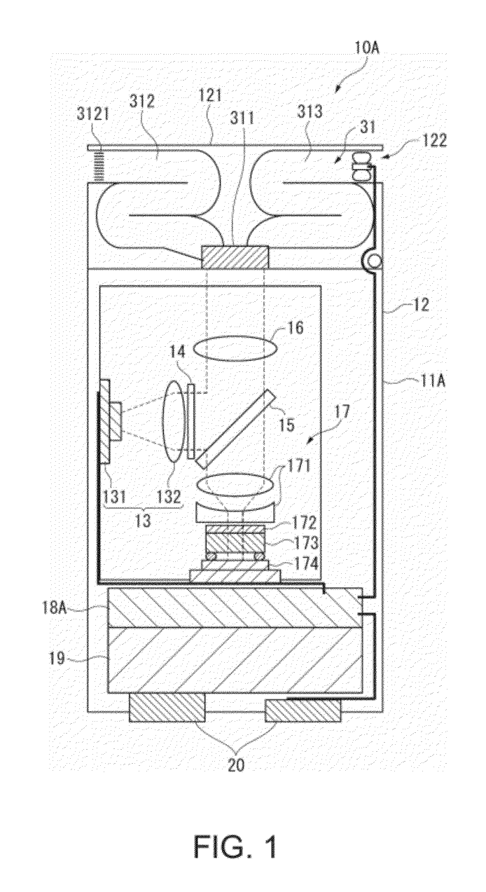

FIG. 1 is a schematic diagram illustrating a configuration of a measurement apparatus 10A according to the first embodiment of the invention. The measurement apparatus 10A according to the present embodiment is a measurement apparatus that identifies a target substance contained in a sample and measures a concentration of the target substance. As shown in FIG. 1, the measurement apparatus 10A includes an apparatus mainframe 11A and an exchange unit 31 exchangeably installed in the apparatus mainframe 11A.

The exchange unit 31 forms a flow path for allowing the sample to pass. In the flow path, a sensor chip 311 is provided. The apparatus mainframe 11A irradiates light (laser light) onto the sensor chip 311, detects the Raman scattering light radiated from the target substance contained in the sample, and measures the concentration of the target substance based on the strength of the Raman scattering light. The configuration of the exchange unit 31 will be described below in detail.

### Configuration of Apparatus Mainframe

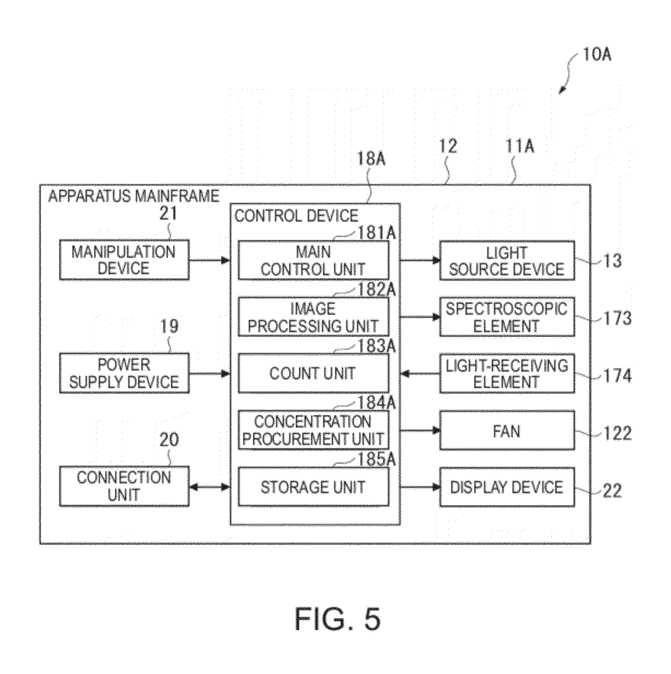

The apparatus mainframe 11A identifies and quantitatively measures the target substances contained in the sample passing through the exchange unit 31. The apparatus mainframe 11A includes a casing 12, a light source device 13 provided in the casing 12, a beam splitting device 14, a half mirror 15, an object lens 16, a detection device 17, a control device 18A, a power supply device 19, and a connection unit 20 exposed outside the casing 12 to serve as an interface to an external device. In addition, although not shown in FIG. 1, the apparatus mainframe 11A has a manipulation device 21 (FIG. 5) having a button and the like for manipulating the measurement apparatus 10A and a display device 22 (FIG. 5) for displaying measurement results. In addition, the configuration of the control device 18A will be described below.

The casing 12 is provided with a cover portion 121 openably installed, and the exchange unit 31 is arranged in the cover portion 121. In addition, the exchange unit 31 is attached/detached by opening the cover portion 121.

In addition, a fan 122 is provided as a discharge unit in the cover portion 121. The drive of the fan 122 is controlled by the control device 18A. As the fan 122 is driven, the sample is introduced into the exchange unit 31.

The light source device 13 corresponds to the light source according to the invention. The light source device 13 includes a light-emitting unit 131 having vertical resonance surface-emitting laser for emitting monochrome linearly-polarized light and a collimator lens 132 for collimating the laser light emitted from the light-emitting unit 131. A diameter of the laser light emitted from the light-emitting unit 131 is set to 1 μm to 1 mm. In addition, the light emitted from the light-emitting unit 131 is incident to the beam splitting device 14 through the collimator lens 132.

The beam splitting device 14 splits the light beams incident from the light source device 13 into a plurality of partial light beams, and the split partial light beams are incident to the half mirror 15. As such a beam splitting device 14, a beam splitter may be exemplified. According to the present embodiment, such abeam splitting device 14 corresponds to the irradiation unit according to the invention.

The half mirror 15 reflects the light beams incident from the light source device 13 through the beam splitting device 14 toward the sensor chip 311. Specifically, the half mirror 15 bends the optical path of the partial light beams incident from the beam splitting device 14 by 90°, and the partial light beams are incident to the object lens 16.

The object lens 16 includes a collimator lens according to the present embodiment. The object lens 16 collimates the partial light beams incident through the half mirror 15, and each partial light beam is incident to each the sensor chip 311.

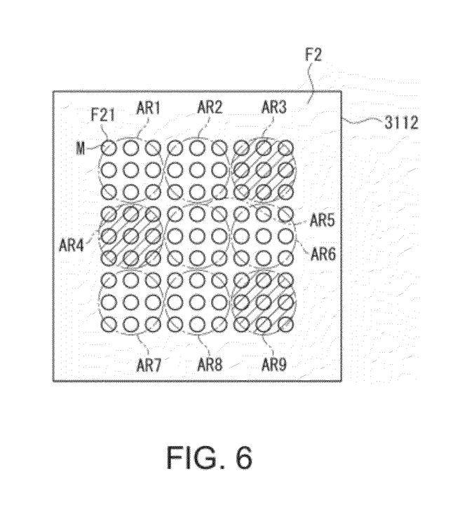

As will described in detail below, the Rayleigh scattering light and the Raman scattering light caused by the surface enhanced Raman scattering are radiated from each area AR1 to AR9 (FIG. 6) where each partial light beam is incident. In addition, the Rayleigh scattering light and the Raman scattering light transmit through the object lens 16 and the half mirror 15, and are incident to the detection device 17.

The detection device 17 is positioned in the side opposite to the object lens 16 and the sensor chip 311 by interposing the half mirror 15 and is arranged along the extension line of the center axis of the light reflected by the half mirror 15 (in other words, along the center axis of the light transmitting through the half mirror 15). The detection device 17 selectively detects the Raman scattering light out of the Rayleigh scattering light and the Raman scattering light radiated from the areas AR1 to AR9 in the sensor chip 311.

The detection device 17 includes a condensing lens 171, a filter 172, a spectroscopic device 173, and a light-receiving element 174.

The condensing lens 171 condenses the Rayleigh scattering light and the Raman scattering light incident through the half mirror 15 and causes them to enter the filter 172.

The filter 172 transmits the Raman scattering light out of the incident Rayleigh scattering light and the incident Raman scattering light. That is, the filter 172 removes the Rayleigh scattering light.

The spectroscopic device 173 has a configuration capable of selecting the wavelength of the transmitted light under control of the control device 18A. The spectroscopic device 173 can be made from, for example, a variable etalon spectrometer capable of adjusting the resonance wavelength.

The light-receiving element 174 corresponds to the light-receiving unit according to the invention. The light-receiving element receives the Raman scattering light incident through the spectroscopic device 173 and captures images of each area AR1 to AR9 of the sensor chip 311. The light-receiving element 174 outputs the captured image to the control device 18A.

### Configuration of Exchange Unit

The exchange unit 31 is detachably installed in the cover portion 121 as described above, and the sample passes through the inner side thereof. The exchange unit 31 is exchanged whenever the sample is measured. The exchange unit 31 includes a sensor chip 311 as a light-incident body, a guide unit 312 for guiding the sample to the sensor chip 311, and a discharge unit 313 for discharging the sample passing through the sensor chip 311.

Each of the guide unit 312 and the discharge unit 313 includes an S-shaped duct as seen from the cross-sectional view.

One end of the guide unit 312 is provided with a dustproof filter 3121 for removing relatively large dust particles, a part of moisture, and the like, and the other end is connected to the sensor chip 311.

One end of the discharge unit 313 is connected to the sensor chip 311, and the other end is connected to the fan 122 described above.

In addition, as the fan 122 is driven, the sample is introduced into the guide unit 312 through the dustproof filter 3121, passes through the guide unit 312, and arrives at the sensor chip 311. In addition, the sample passing through the sensor chip 311 passes through the discharge unit 313 and is discharged outside by the fan 122. That is, a flow path for passing the sample is formed in each of the guide unit 312, the sensor chip 311, and the discharge unit 313.

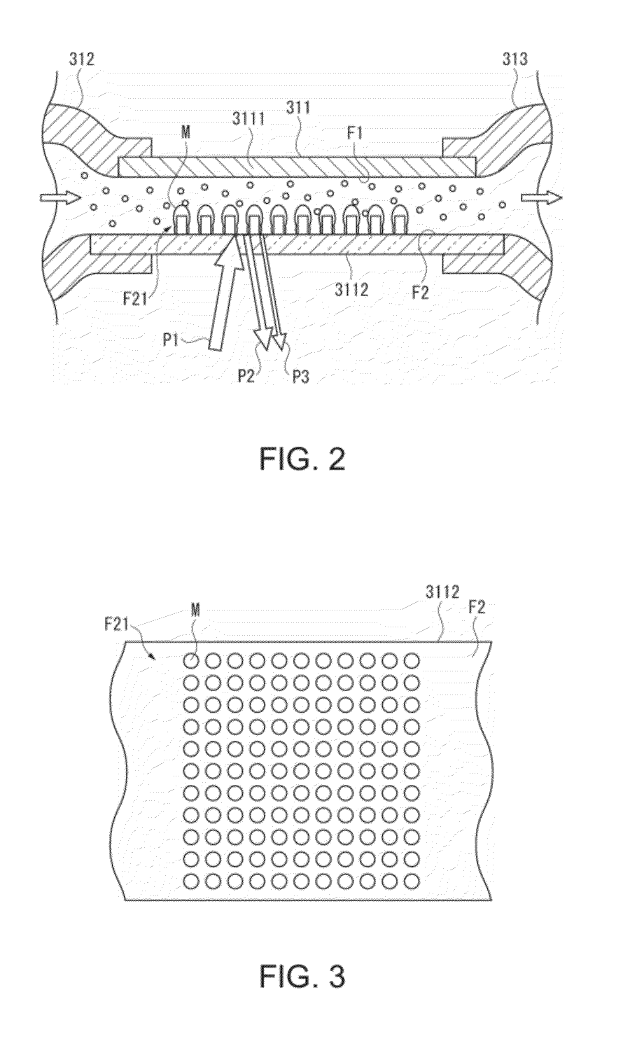

FIG. 2 is a cross-sectional view schematically illustrating the sensor chip 311. In FIGS. 2 and 3 described below, only a part of the metal particulates and protrusions are denoted by the reference numerals M and F21, respectively, for brevity purposes.

The sensor chip 311 corresponds to the light-incident body according to the invention. As shown in FIG. 2, in the sensor chip 311, a light P1 (partial light beams) emitted from the light source device 13 is incident to the sample passing through the inner side so as to radiate a Rayleigh scattering light P2 and a Raman scattering light P3 described above from the target substance contained in the sample. In such a sensor chip 311, a flow path for passing the sample is formed between a pair of substrates 3111 and 3112 having transparency, and sample contact surfaces F1 and F2 making contact with the sample are formed in the substrate 3111 and 3112, respectively, facing each other.

FIG. 3 is a plan view illustrating the sample contact surface F2 of the sensor chip 311.

As shown in FIG. 3, the sample contact surface F2 formed in the substrate 3112 near the apparatus mainframe 11A is provided with a plurality of cylindrical protrusions F21 in a grid shape within a rectangular range having a width of 5 mm as shown in FIG. 3. The pitch between the protrusions F21 is set to, for example, 300 nm or more within a range equal to or smaller than the oscillation wavelength of the laser light emitted from the light source device 13.

In this manner, each protrusion F21 arranged in a grid shape is coated by the SERS active metal particles (hereinafter, also referred to as metal particulates) M. The gap between each protrusion F21 covered by the metal particulates M is set to, for example, 1 nm or more within a range equal to or smaller than a half of the aforementioned pitch. Such metal particulates M may include gold, silver, copper, aluminum, palladium, and platinum.

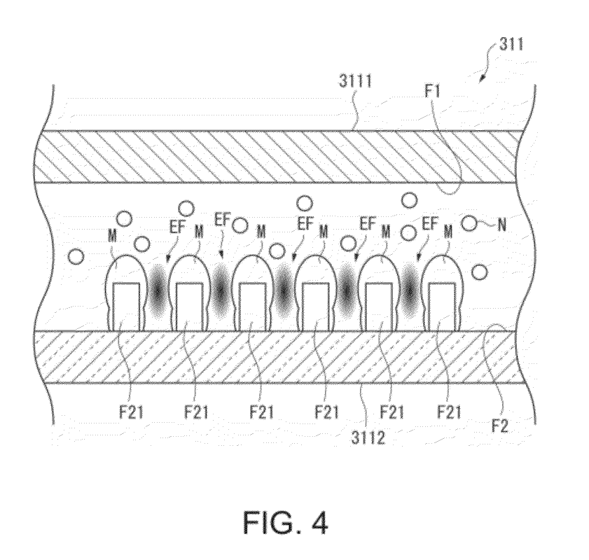

FIG. 4 is a schematic diagram illustrating an enhanced electric field EF formed on the sample contact surface F2. In FIG. 4, for brevity purposes, a part of molecules of the target substance are denoted by the reference symbol N.

As the light from the light source device 13 is incident to the sample contact surface F2 having a plurality of protrusions F21 where metal particulates M are coated, the enhanced electric field EF is formed in the gap between each protrusion F21. When the molecules N of the target substance invade into the enhanced electric field EF, Rayleigh scattering light P2 and Raman scattering light P3 (refer to FIG. 2) including information on the frequency of the molecules N are generated. At this moment, the surface enhanced Raman scattering is generated by the enhanced electric field EF, and the radiated Raman scattering light is enhanced. The Rayleigh scattering light P2 and the Raman scattering light P3 radiated in this manner are incident to the detection device 17 via the object lens 16 and the half mirror 15 as described above, and the Raman scattering light P3 is received by the light-receiving element 174.

### Configuration of Control Device

FIG. 5 is a block diagram illustrating a configuration of the apparatus mainframe 11A, and is a block diagram mainly illustrating a configuration of the control device 18A.

The control device 18A includes a circuit board where a central processing unit (CPU), a random access memory (RAM), a read only memory (ROM), and the like are mounted to control the entire measurement apparatus 10A. The control device 18A serves as the main control unit 181A, the image processing unit 182A, the count unit 183A, and the concentration procurement unit 184A shown in FIG. 5 by allowing the CPU to process the program stored in the ROM and has a storage unit 185A. Such a control device 18A serves as a quantitative measurement unit according to the invention.

The storage unit 185A may include a hard disk drive (HDD), a solid-state memory, and the like in addition to the ROM as described above. Such a storage unit 185A stores a fingerprint spectrum unique to a substance in relation to the name of the substance.

In addition, the storage unit 185A stores, for each target substance, a look-up table (LUT) including concentrations of the target substance contained in the sample passing through the exchange unit 31 in relation to the number of areas, where the Raman scattering light is received by the light-receiving element 174, depending on the concentration. Specifically, the LUT is created as a table by measuring, in advance, the number of areas where the Raman scattering light radiated from the target substance is detected when the samples having different concentrations of the target substance pass through the exchange unit 31, and the partial light beams described above are irradiated onto the sensor chip 311 and associating the number of areas with the concentration of the target substance.

In addition, since it is difficult to measure the number of areas for all of the concentrations of the target substances in practice, a calibration curve regarding each concentration of the target substance and the number of areas corresponding to the concentrations is created, and the LUT is created based on the calibration curve. For this reason, the invention may be configured to store an approximation function of the calibration curve instead of the LUT.

The main control unit 181A controls the entire apparatus mainframe 11A. For example, the main control unit 181A controls turning on/off of the light source device 13, adjustment of the transmissive wavelength of the spectroscopic device 173, driving of the fan 122, and display of the display device 22.

The image processing unit 182A obtains the captured image from the light-receiving element 174 and executes a predetermined correction process for the captured image. In addition, the image processing unit 182A obtains a fingerprint spectrum unique to the target substance using the spectroscopic device 173 based on the received Raman scattering light from the captured image and obtains the name of the substance corresponding to the fingerprint spectrum with reference to the storage unit 185A. That is, the image processing unit 182A also serves as a qualitative analysis unit for identifying the target substance.

FIG. 6 is a diagram illustrating an exemplary captured image processed by the image processing unit 182A.

The count unit 183A counts the number of areas where the Raman scattering light of the target substance is detected out of the areas onto which the partial light beams are irradiated in the sample contact surface F2 described above based on the captured image obtained by the image processing unit 182A. For example, in a case where the beam splitting device 14 splits the light emitted from the light source device 13 into 9 partial light beams, and each partial light beam is incident to the areas AR1 to AR9 on the sample contact surface F2 as shown in FIG. 6, the count unit 183A recognizes the positions of the areas AR1 to AR9 in the captured image and counts the number of areas (three areas AR3, AR4, and AR9 in the example of FIG. 6) where the luminance exceeds a predetermined value out of the areas AR1 to AR9. The predetermined value may be set to a luminance value when the Raman scattering light enhanced by the enhanced electric field described above is detected.

Returning to FIG. 5, the concentration procurement unit 184A obtains the concentration of the target substance corresponding to the number of areas counted by the count unit 183A with reference to the LUT stored in the storage unit 185A. In this case, the concentration procurement unit 184A allows reference to an item of the LUT corresponding to the name of the target substance identified by the image processing unit 182A. The concentration of the target substance obtained in such a manner is displayed on the display device 22 under control of the main control unit 181A.

Hereinafter, the concentration measurement process for the target substance using the measurement apparatus 10A will be described.

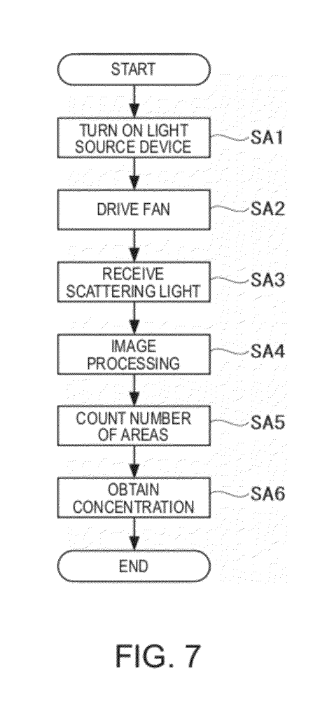

FIG. 7 is a flowchart illustrating the concentration measurement process.

The control device 18A executes the concentration measurement process for the target substance contained in the sample passing though the exchange unit 31 by processing the concentration measurement program.

In the concentration measurement process, as shown in FIG. 7, the main control unit 181A turns on the light source device 13 and irradiates the partial light beams onto the sensor chip 311 (step SA1).

Simultaneously with or after step SA1, the main control unit 181A drives the fan 122 to guide the sample to the exchange unit 31 (step SA2).

As a result, the sample is introduced into the sensor chip 311 through the guide unit 312 and makes contact with the sample contact surfaces F1 and F2. If the molecules of the target substance invade into the enhanced electric field EF (FIG. 4) formed when the partial light beam is incident as described above, the enhanced Raman scattering light and the enhanced Rayleigh scattering light are radiated as described above. That is, steps SA1 and SA2 correspond to the scattering light enhancement step according to the invention.

Next, the light-receiving element 174 of the detection device 17 receives the Raman scattering light transmitting through the spectroscopic device 173 (step SA3), and the image processing unit 182A processes the captured image from the light-receiving element 174 (step SA4). In this case, the image processing unit 182A obtains the fingerprint spectrum of the target substance and identifies the target substance based on the Raman scattering light received by the light-receiving element 174.

In addition, the count unit 183A counts the number of areas, where the enhanced Raman scattering light is detected, based on the obtained captured image (step SA5).

Then, the concentration procurement unit 184A obtains the concentration of the target substance corresponding to the number of areas counted by the count unit 183A with reference to the LUT stored in the storage unit 185A depending on the target substance (step SA6). That is, according to the present embodiment, steps SA5 and SA6 correspond to the quantitative step according to the invention.

As a result, the concentration measurement process is terminated.

The following effects can be obtained using the measurement apparatus 10A according to the present embodiment described above.

The count unit 183A counts the number of areas where the Raman scattering light of the target substance is received out of a plurality of areas AR1 to AR9. As a result, the number of the counted areas indicates a ratio between a total number of the areas AR1 to AR9 where the light is incident from the light source device 13 and the number of the areas where the Raman scattering light of the target substance is received, and the ratio corresponds to a value indirectly indicating an averaged distribution ratio of the target substance. In addition, the concentration procurement unit 184A can obtain the concentration of the target substance by obtaining the concentration corresponding to the number of the areas with reference to the LUT of the corresponding target substance stored in the storage unit 185A. Therefore, it is possible to measure the concentration of the target substance contained in the sample.

Using the beam splitting device 14, the light emitted from the light source device 13 can be incident to a plurality of areas AR1 to AR9 on the sample contact surface F2 of the sensor chip 311 in one time. As a result, compared to a case where the light is individually incident from the light source device 13 to the positions of each area AR1 to AR9, it is possible to shorten the time necessary to receive the Raman scattering light from each area AR1 to AR9. Therefore, it is possible to measure the concentration of the target substance within a short time.

### Second Embodiment

Next, the second embodiment of the invention will be described.

A measurement apparatus according to the present embodiment has the same configuration as that of the measurement apparatus 10A described above. Here, in the measurement apparatus 10A, the concentration corresponding to the number of areas where the enhanced Raman scattering light on the sample contact surface F2 is detected is obtained from the LUT of the storage unit 185A. In comparison, in the measurement apparatus according to the present embodiment, a total sum of the strengths of the Raman scattering light received from each area is computed, and the concentration corresponding to the total sum is obtained from the storage unit. In this regard, the measurement apparatus according to the present embodiment is different from the measurement apparatus 10A. In the following description, like reference numerals denote like elements as in the aforementioned description, and description thereof will not be repeated.

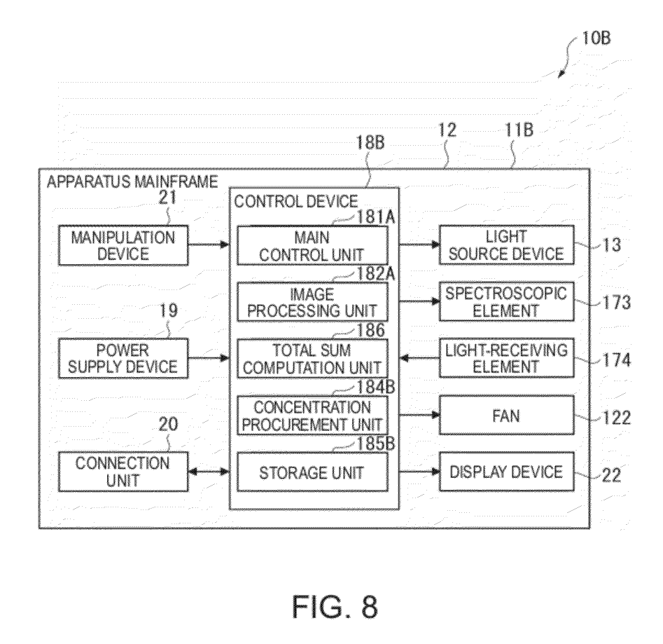

FIG. 8 is a block diagram illustrating a configuration of the measurement apparatus 10B according to the present embodiment.

A measurement apparatus 10B according to the present embodiment has the same configuration and function as those of the measurement apparatus 10A described above except that an apparatus mainframe 11B is employed instead of the apparatus mainframe 11A. The apparatus mainframe 11B has the same configuration and function as those of the apparatus mainframe 11A except that a control device 18B is employed instead of the control device 18A.

The control device 18B has the same configuration and function as those of the control device 18A described above except that a total sum computation unit 186, a concentration procurement unit 184B, and a storage unit 185B are employed instead of the count unit 183A, the concentration procurement unit 184A, and the storage unit 185A as shown in FIG. 8.

The storage units 185B and 185A have the same configuration and store the same information. Furthermore, the storage unit 185B stores, for each target substance, an LUT for storing the concentrations of the target substance contained in the sample passing through the exchange unit 31 in relation to total sums of the strengths of the Raman scattering light received from each area AR1 to AR9 (FIG. 6) on the sample contact surface F2 depending on the concentration. Specifically, the LUT is created as a table obtained by measuring, in advance, a total sum of the strengths of the Raman scattering light received from each area AR1 to AR9 when the samples having different concentrations of the target substance pass through the exchange unit 31, and the partial light beams described above are irradiated onto the sensor chip 311 and associating the total sum with the concentration of the target substance.

Similar to the aforementioned case, since it is difficult to compute a total sum for all of the concentrations of the target substance in practice, a calibration curve regarding each concentration of the target substance and a total sum of the strengths of the Raman scattering light corresponding to the concentration is created, and the LUT is created based on the calibration curve. For this reason, instead of the LUT, an approximation function of the calibration curve may be stored.

The total sum computation unit 186 computes a total sum of the strengths of the Raman scattering light of the target substance received from each area AR1 to AR9 based on the captured image processed by the image processing unit 182A.

The concentration procurement unit 184B obtains the concentration of the target substance corresponding to the total sum computed by the total sum computation unit 186 from the LUT of the corresponding target substance of the storage unit 185B.

Hereinafter, the concentration measurement process of the target substance using the measurement apparatus 10B will be described.

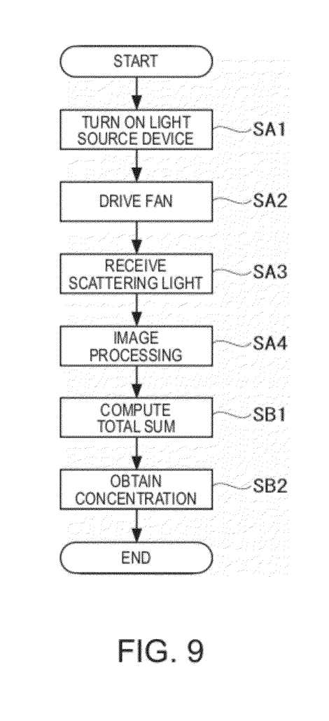

FIG. 9 is a flowchart illustrating the concentration measurement process.

The control device 18B processes the concentration measurement program and executes the concentration measurement process for the target substance contained in the sample passing through the exchanging unit 31.

In the concentration measurement process, as shown in FIG. 9, the control device 18B executes the process similar to that of steps SA1 to SA4 described above.

In addition, the total sum computation unit 186 computes a total sum of the strengths of the Raman scattering light received from each area AR1 to AR9 based on the processed captured image (step SB1).

Then, the concentration procurement unit 184B obtains the concentration of the target substance corresponding to the computed total sum with reference to the LUT of the identified target substance (step SB2). That is, according to the present embodiment, steps SB1 and SB2 correspond to the quantitative measuring step according to the invention.

As a result, the concentration of the target substance contained in the sample is measured.

In the measurement apparatus 10B according to the present embodiment described above, it is possible to obtain the same effects as those of the aforementioned measurement apparatus 10A.

Specifically, the total sum computation unit 186 computes a total sum of strengths of the Raman scattering light received by the light-receiving element 174 from the areas AR1 to AR9. As a result, the computed total sum of the strengths indicates a ratio with respect to the maximum strength of the Raman scattering light received from all of the areas AR1 to AR9. The ratio corresponds to a value indirectly indicating an averaged distribution ratio of the target substance. In addition, it is possible to obtain the concentration of the target substance using the concentration procurement unit 184B by obtaining the concentration depending on the computed total sum of the strengths with reference to the LUT of the target substance corresponding to the storage unit 185B. Therefore, it is possible to measure the concentration of the target substance contained in the sample.

### Third Embodiment

Next, the third embodiment of the invention will be described.

A measurement apparatus according to the present embodiment has the same configuration as those of the measurement apparatuses 10A and 10B described above. Here, in the measurement apparatus 10A, the light emitted from the light source device 13 is split into a plurality of partial light beams, and the concentration of the target substance is measured based on the strengths of the Raman scattering light received from each area where each partial light beam is received on the sample contact surface F2. In comparison, in the measurement apparatus according to the present embodiment, the position of the area where the light is incident on the sample contact surface F2 is changed, and the Raman scattering light is received by each area to measure the concentration of the target substance. In this regard, the measurement apparatus according to the present embodiment is different from the measurement apparatuses 10A and 10B described above. In addition, in the following description, like reference numerals denote like elements as in those described above, and description thereof will not be repeated.

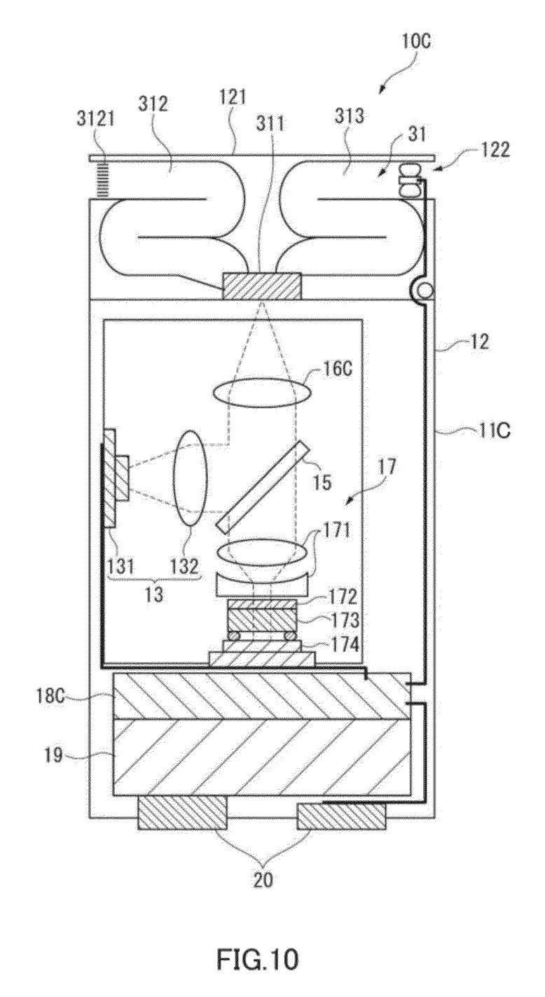

FIG. 10 is a schematic diagram illustrating a configuration of a measurement apparatus 10C according to the present embodiment.

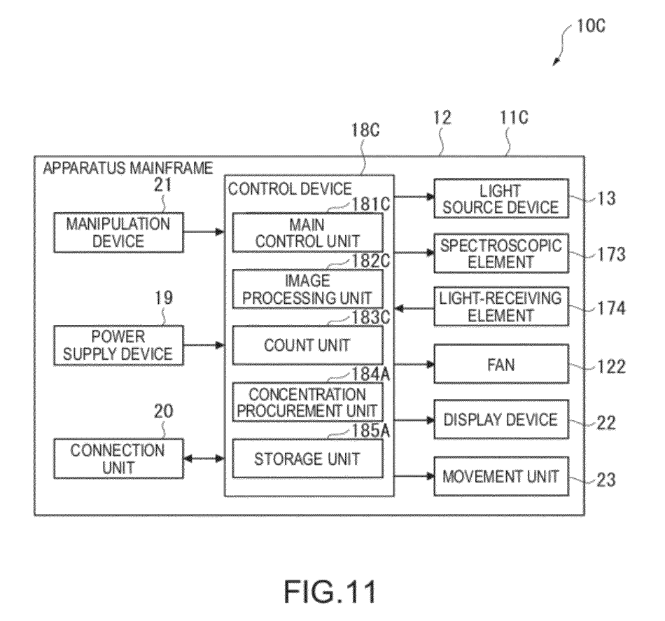

FIG. 11 is a block diagram illustrating a configuration of an apparatus mainframe 11C of the measurement apparatus 10C.

As shown in FIGS. 10 and 11, the measurement apparatus 10C according to the present embodiment has the configuration and function similar to those of the measurement apparatus 10A described above except that a movement unit 23 (FIG. 11) for shifting the half mirror 15, an object lens 16C (FIG. 10), and a control device 18C (FIGS. 10 and 11) are employed instead of the beam splitting device 14, the object lens 16, and the control device 18A.

As shown in FIG. 10, the object lens 16C focuses the light beam emitted from the light source device 13 and incident through the half mirror 15 to the focal position set on the sensor chip 311 and causes the light beam to enter. The light beam incident through the object lens 16C is set to a range having a diameter equal to or larger than 1 μm and equal to or smaller than 1 mm (preferably, equal to or larger than 1 μm and equal to or smaller than 10 μm) on the sample contact surface F2.

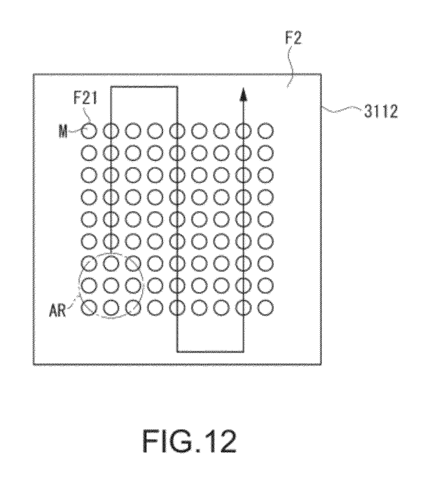

FIG. 12 is a diagram illustrating a movement direction of the area where the light is incident on the sample contact surface F2.

A movement unit 23 includes a motor such as a stepping motor or a guide member for guiding the movement of a movement target. The movement unit 23 rotates the half mirror 15 to change the angle of the half mirror 15 with respect to the center axis of the light incident from the light source device 13. As a result, as shown in FIG. 12, an area AR where the light is incident is moved on the sample contact surface F2 so that the sample contact surface F2 is scanned. In addition, the Raman scattering light is received by the light-receiving element 174 in each position of the moved area AR.

As shown in FIG. 11, the control device 18C has the same configuration and function as those of the control device 18A described above except that a main control unit 181C, an image processing unit 182C, and a count unit 183C are employed instead of the main control unit 181A, the image processing unit 182A, and the count unit 183A, respectively.

The main control unit 181C has the same function as that of the main control unit 181A and controls the operation of the movement unit 23. Under control of the main control unit 181C, the area AR (FIG. 12) where the light is incident on the sample contact surface F2 is moved as described above so that the position of the light incident area AR is changed in a time-division manner on the sample contact surface F2. That is, the main control unit 181C and the movement unit 23 correspond to an adjustment unit according to the invention, and the half mirror 15 corresponds to a reflection unit according to the invention. In the present embodiment, the angle of the half mirror 15 is adjusted to position the area AR in the same location as that of the areas AR1 to AR9 described above using the main control unit 181C and the movement unit 23.

The image processing unit 182C has the same function as that of the image processing unit 182A and obtains the captured image (light-receiving result) input from the light-receiving element 174 whenever the position of the area AR on the sample contact surface F2 is changed by adjusting the angle of the half mirror 15 to process the captured image. In addition, the image processing unit 182C identifies the target substance based on the received Raman scattering light.

The count unit 183C counts the number of areas on the sample contact surface F2, where the enhanced Raman scattering light is received, based on the captured image processed by the image processing unit 182C. In this case, the count unit 183C counts the number of captured images where the Raman scattering light is received out of each captured image obtained for each position of the moved area AR as the number of areas where the Raman scattering light is received on the sample contact surface F2.

The concentration procurement unit 184A obtains the concentration of the target substance corresponding to the number of areas counted by the count unit 183C with reference to the storage unit 185A.

Although the storage unit 185A stores the aforementioned LUT for each target substance, the LUT is not an LUT obtained by associating the number of areas, where the Raman scattering light of the target substance is received, out of a plurality of areas, where each of the aforementioned partial light beams is irradiated, with the concentration of the target substance. That is, the LUT stored in the storage unit 185A according to the present embodiment is an LUT obtained by passing the sample having a predetermined concentration of the target substance through the exchange unit 31, changing the position of the area, where the light is incident, on the sample contact surface F2 using the movement unit 23 and the half mirror 15 in a time-division manner, and associating the number of areas, where the Raman scattering light of the target substance is received, out of each area (the areas of the positions corresponding to the aforementioned areas AR1 to AR9) with the concentration of the target substance.

Next, the concentration measurement process for the target substance using the measurement apparatus 10C will be described.

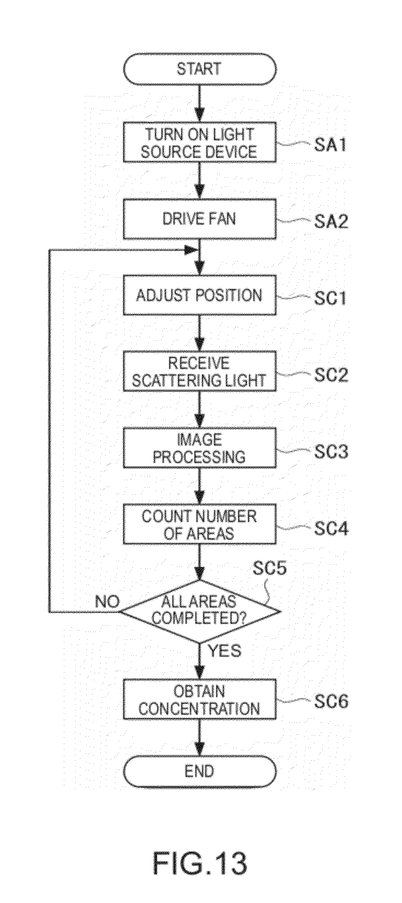

FIG. 13 is a flowchart illustrating the concentration measurement process.

The control device 18C processes the concentration measurement program and executes the concentration measurement process for the target substance contained in the sample passing through the exchange unit 31.

In the concentration measurement process, the control device 18C executes the same process as that of steps SA1 and SA2 described as shown in FIG. 13.

The main control unit 181C adjusts the position of the light incident area on the sample contact surface F2 by controlling the movement unit 23 and adjusting the angle of the half mirror 15 (step SC1), and the light-receiving element 174 receives the Raman scattering light radiated from the area (step SC2).

Then, the image processing unit 182C processes the captured image obtained by the light-receiving element 174 and identifies the fingerprint spectrum using the spectroscopic device 173 to identify the target substance (step SC3). The count unit 183C counts the number of the captured images, where the Raman scattering light is detected, as the number of areas described above based on the obtained captured images (step SC4).

Then, the main control unit 181C determines whether or not the light from the light source device 13 is incident for all of the predetermined areas (positions corresponding to the areas AR1 to AR9 described above) on the sample contact surface F2 (step SC5).

Here, if it is determined that there is an area where no light is incident, the control device 18C returns the process to step SC1. As a result, the main control unit 181C executes aforementioned positional adjustment again to change the position of the area where the light is incident on the sample contact surface F2.

Meanwhile, if it is determined that the light is incident onto all of the areas, the concentration procurement unit 184A obtains the concentration of the target substance corresponding to the counted number of the areas from the storage unit 185A (step SC6). That is, according to the present embodiment, steps SC4 and SC6 correspond to the quantitative step according to the invention.

As a result, the concentration measurement process is terminated, and the target substance contained in the sample is quantitatively measured.

In the measurement apparatus 10C according to the present embodiment described above, it is possible to obtain the following effects in addition to the same effects as those of the measurement apparatus 10A.

That is, the count unit 183C counts the number of the areas where the Raman scattering light of the target substance is received out of the areas (areas of the positions corresponding to the aforementioned areas AR1 to AR9), where the light from the light source device 13 is incident, on the sample contact surface F2. In addition, the concentration procurement unit 184A can obtain the concentration of the target substance by obtaining the concentration corresponding to the number of the areas with reference to the LUT of the corresponding target substance stored in the storage unit 185A. Therefore, it is possible to measure the concentration of the target substance contained in the sample.

The light emitted from the light source device 13 and incident to the sample contact surface F2 through the half mirror 15 is incident in a time-division manner by changing the position on the sample contact surface F2 using the movement unit 23 for moving the half mirror 15. As a result, the light emitted from the light source device 13 is incident to each area (areas corresponding to the aforementioned areas AR1 to AR9) of the sample contact surface F2 without being split into a plurality of light beams. Therefore, it is possible to prevent reduction and a deviation of the strength of the light incident to each area and increase the strength of the enhanced electric field. Therefore, in comparison with a case where split light beams are incident to the sample contact surface F2, it is possible to generate Raman scattering light having a higher strength and improve light-receiving precision using the light-receiving element 174.

The light emitted from the light source device 13 is reflected by the half mirror 15, of which an angle with respect to the center axis of the light is adjusted by the movement unit 23, and is incident to each area of the sample contact surface F2. As a result, in comparison with a case where the sensor chip 311 connected to the guide unit 312 and the discharge unit 313 is moved, it is possible to prevent the configuration of the measurement apparatus 10C from being complicated.

In addition, since the movement unit 23 changes the area where the light is incident to the sample contact surface F2 by moving the half mirror 15 for splitting the optical path of the light emitted from the light source device 13 and the optical path of the light radiated from the sample contact surface F2, it is not necessary to separately provide a reflection unit for changing the location where the light is incident. For this reason, it is possible to divert the configuration of the measurement apparatus having the half mirror 15.

### Fourth Embodiment

Next, the fourth embodiment of the invention will be described.

A measurement apparatus according to the present embodiment has a configuration similar to that of the measurement apparatus 10C described above. Here, similar to the measurement apparatus 10A, the measurement apparatus 10C has a configuration in which the concentration of the target substance is obtained depending on the number of areas where the enhanced Raman scattering light is detected on the sample contact surface F2. In comparison, similarly to the measurement apparatus 10B described above, the measurement apparatus according to the present embodiment obtains a concentration of the target substance depending on a total sum of the Raman scattering light detected from each area. At this point, the measurement apparatus according to the present embodiment is different from the measurement apparatus 10C. In the following description, like reference numerals denote like elements, and description thereof will not be repeated.

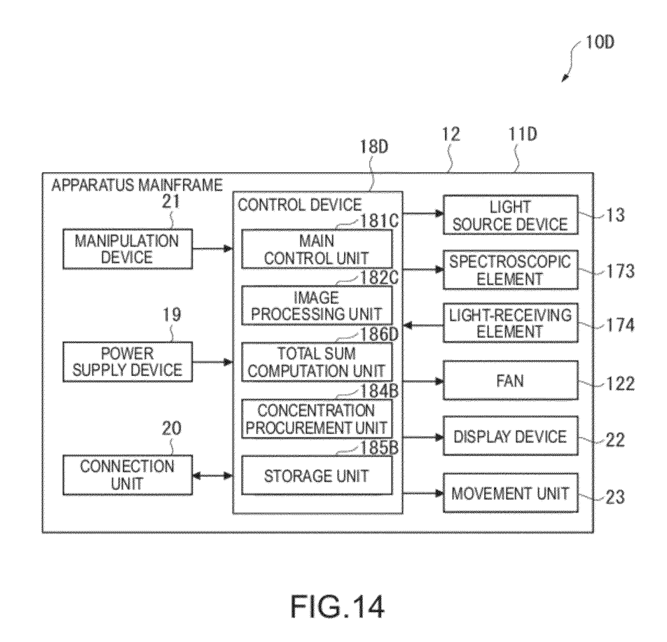

FIG. 14 is a block diagram illustrating a configuration of an apparatus mainframe 11D of a measurement apparatus 10D according to the present embodiment.

The measurement apparatus 10D according to the present embodiment has the same configuration and function as those of the measurement apparatus 10C described above except that a control device 18D is provided instead of the control device 18C as shown in FIG. 14.

The control device 18D has a configuration and a function similar to those of the control device 18C except that a total sum computation unit 186D, the concentration procurement unit 184B, and the storage unit 185B are provided instead of the count unit 183C, the concentration procurement unit 184A, and the storage unit 185A.

While the total sum computation unit 186D has a function similar to that of the total sum computation unit 186, the total sum computation unit 186D is different from the total sum computation unit 186 in that a total sum of the strengths of the enhanced Raman scattering light is computed based on each captured image input from the image processing unit 182C and processed whenever the position of the area where the light is incident on the sample contact surface F2 is changed. That is, the total sum computation unit 186D adds up each of the strengths of the Raman scattering light obtained from each captured image to compute a total sum of the strengths of the Raman scattering light received from a plurality of areas on the sample contact surface F2.

In addition, the concentration procurement unit 184B obtains the concentration of the identified target substance based on the total sum of the strengths with reference to the corresponding LUT of the storage unit 185B.

The LUT stored in the storage unit 185B is an LUT obtained by passing the sample of which the concentration of the target substance is set in advance through the exchange unit 31, changing the position of the area where the light is incident on the sample contact surface F2 using the movement unit 23 and the half mirror 15 in a time-division manner, and associating a total sum of the strengths of the Raman scattering light of the target substance received from each area (the areas of the positions corresponding to the aforementioned areas AR1 to AR9) with the concentration of the target substance.

Next, the concentration measurement process for the target substance using the measurement apparatus 10D will be described.

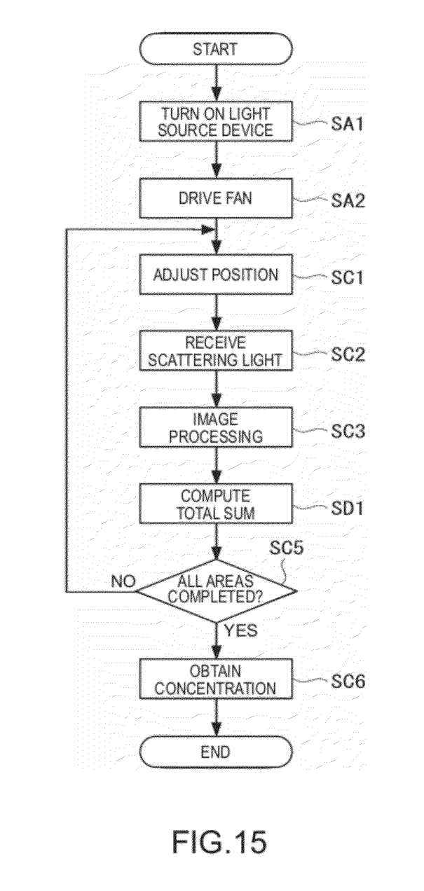

FIG. 15 is a flowchart illustrating the concentration measurement process.

The control device 18D processes the concentration measurement program and executes the concentration measurement process for the target substance contained in the sample passing through the exchange unit 31.

In the concentration measurement process, as shown in FIG. 15, the control device 18D executes the process such as steps SA1, SA2, and SC1 to SC3 described above.

After step SC3, the total sum computation unit 186D computes a total sum of the strengths of the Raman scattering light based on the captured image processed by the image processing unit 182C (step SD1).

Then, the control device 18D executes step SC5 described above. If it is determined that the light is incident to all of the predetermined areas in step SC5, the concentration procurement unit 184B obtains the concentration of the target substance corresponding to the computed total sum of the strengths from the storage unit 185B (step SC6). That is, according to the present embodiment, steps SD1 and SC6 correspond to the quantitative step according to the invention.

As a result, the concentration measurement process is terminated, and the target substance contained in the sample is quantitatively measured.

In the measurement apparatus 10D according to the present embodiment described above, it is possible to obtain the same effects as those of the measurement apparatuses 10B and 10C described above.

That is, the total sum computation unit 186D computes a total sum of the strengths of the Raman scattering light received by the light-receiving element 174 from the incidence area (area AR of the location corresponding to the areas AR1 to AR9) of the light moved to scan the sample contact surface F2 on the sample contact surface F2. In addition, the concentration procurement unit 184B can obtain the concentration of the target substance by obtaining the concentration corresponding to the computed total sum of the strengths with reference to the LUT of a target substance corresponding to the storage unit 185B. Therefore, it is possible to measure the concentration of the target substance contained in the sample.

The light emitted from the light source device 13 is incident in a time-division manner by changing the position on the sample contact surface F2 using the movement unit 23 and the half mirror 15. As a result, in comparison with a case where the light emitted from the light source device 13 is split into a plurality of light beams, and a plurality of light beams are incident to the sample contact surface F2, it is possible to prevent reduction of the strength of the light incident to the sample contact surface F2 and increase the strength of the enhanced electric field. Therefore, it is possible to generate the Raman scattering light with a high strength and improve light-receiving precision in the light-receiving element 174.

Since the movement unit 23 has a configuration in which the half mirror 15 is moved, it is possible to prevent the configuration of the measurement apparatus 10D from being complicated in comparison with a case where the sensor chip 311 is moved. In addition, since the existing half mirror 15 is employed as a movement target of the movement unit 23 for changing the incidence position of the light to the sample contact surface F2, a separate reflection unit is not necessary. For this reason, it is possible to divert the configuration of the measurement apparatus having the half mirror 15.

### Fifth Embodiment

Next, the fifth embodiment of the invention will be described.

A measurement apparatus according to the present embodiment has the same configuration as that of the measurement apparatus 10C described above. Here, in the measurement apparatus 10C, the movement target moved by the movement unit 23 to change the incidence position of the light to the sample contact surface F2 is the half mirror 15. In comparison, in the measurement apparatus according to the present embodiment, the movement target is the sensor chip 311. In this point, the measurement apparatus of the present embodiment is different from the measurement apparatus 10C.

According to the present embodiment, the movement unit 23 serves as a light-incident body movement unit according to the invention. The movement unit 23 translates the sensor chip 311 in a direction perpendicular to the center axis of the light to change the incidence position of the light to the sample contact surface F2 under control of the main control unit 181C serving as a control unit. As a result, the position of the area AR where the light is incident on the sample contact surface F2 is changed as shown in FIG. 12.

In this configuration, it is possible to obtain the same effects as those of the measurement apparatus 10C by executing the process similar to the concentration measurement process executed by the measurement apparatus 10C. That is, it is possible to obtain the concentration of the target substance by counting the number of areas, where the Raman scattering light of the target substance is received, using the count unit 183C and obtaining the concentration corresponding to the number of areas with reference to the LUT of the corresponding target substance stored in the storage unit 185A. Therefore, it is possible to measure the concentration of the target substance contained in the sample.

Since the movement unit 23 translates the sensor chip 311 in a direction perpendicular to the center axis of the light incident to the sample contact surface F2, the angle between the sample contact surface F2 and the center axis of the incidence light becomes constant (perpendicular) in each area of the sample contact surface F2 where the light is incident. As a result, since it is possible to prevent a deviation in receiving the Raman scattering light in each area, it is possible to improve reliability of the measured concentration. In addition, since the center axis of the light incident to the sample contact surface F2 can be easily directed perpendicularly to the sample contact surface F2, it is possible to stabilize light-receiving of the Raman scattering light.

The measurement apparatus according to the present embodiment has the same configuration as that of the measurement apparatus 10C and has the control device 18C. Alternatively, the control device 18D may be provided instead of the control device 18C. In such a configuration, it is possible to obtain the same effects as those of the measurement apparatus 10D by executing the process similar to the concentration measurement process executed by the measurement apparatus 10D using the measurement apparatus according to the present embodiment.

That is, it is possible to obtain the concentration of the target substance by computing a total sum of the strengths of the Raman scattering light received from each area on the sample contact surface F2, where the light from the light source device 13 is incident, using the total sum computation unit 186D and obtaining the concentration corresponding to the computed total sum of the strengths from the LUT of the corresponding target substance using the concentration procurement unit 184B. Therefore, it is possible to measure the concentration of the target substance contained in the sample.

### Sixth Embodiment

Next, the sixth embodiment of the invention will be described.

A measurement apparatus according to the present embodiment has the same configuration as that of the measurement apparatus 10C described above. Here, in the measurement apparatus 10C, the movement target of the movement unit 23 is the half mirror 15 as described above. In comparison, in the measurement apparatus according to the present embodiment, the movement target is the light source device 13. At this point, the measurement apparatus according to the present embodiment is different from the measurement apparatus 10C.

The movement unit 23 serves as the light source movement unit according to the present embodiment. The movement unit 23 translates the light source device 13 in a direction perpendicular to the center axis of the light emitted from the light source device 13 under control of the main control unit 181C serving as a control unit. As a result, the position of the area AR where the light is incident on the sample contact surface F2 is changed as shown in FIG. 12.

In this configuration, it is possible to obtain the same effects as those of the measurement apparatus 10C by executing the process similar to the concentration measurement process executed by the measurement apparatus 10C.

That is, it is possible to obtain the concentration of the target substance by counting the number of areas, where the Raman scattering light of the target substance is received, using the count unit 183C and obtaining the concentration corresponding to the number of areas with reference to the LUT of the corresponding target substance using the concentration procurement unit 184A. Therefore, it is possible to measure the concentration of the target substance contained in the sample.

Since the movement unit 23 translates the light source device 13 in a direction perpendicular to the center axis of the light emitted from the light source device 13, the angle between the sample contact surface F2 and the center axis of the incident light becomes constant (perpendicular) in each area on the sample contact surface F2 where the light is incident. As a result, since it is possible to prevent a deviation in receiving the Raman scattering light in each area, it is possible to improve reliability of the measured concentration. In addition, since the center axis of the light incident to the sample contact surface F2 can be easily directed perpendicularly to the sample contact surface F2, it is possible to stabilize light-receiving of the Raman scattering light.

In addition, since the movement unit 23 moves the light source device 13, it is not necessary to move the sensor chip 311, and it is possible to suppress the configuration of the measurement apparatus from being complicated.

In the measurement apparatus according to the present embodiment, the movement unit 23 may be configured such that the light source device 13 is rotated with respect to the rotation axis along the direction perpendicular to the center axis of the light emitted from the light source device 13. In this case, it is possible to change the position of the area AR on the sample contact surface F2.

The measurement apparatus according to the present embodiment has the same configuration as that of the measurement apparatus 10C and has the control device 18C. However, the control device 18D may be provided instead of the control device 18C. In this configuration, it is possible to obtain the same effects as those of the measurement apparatus 10D by executing the process similar to the concentration measurement process executed by the measurement apparatus 10D using the measurement apparatus according to the present embodiment.

That is, it is possible to obtain the concentration of the target substance by computing a total sum of the strengths of the Raman scattering light received from each area of the sample contact surface F2, where the light is incident from the light source device 13, using the total sum computation unit 186D and obtaining the concentration of the computed total sum of the strengths from the LUT of the corresponding target substance using the concentration procurement unit 184B. Therefore, it is possible to measure the concentration of the target substance contained in the sample.

### Modification of Embodiments

Embodiments of the invention are not limited to those described above, but may be variously modified or changed within the spirit and scope of the invention.

In each embodiment described above, the pitch of each protrusion F21 formed in the sample contact surface F2, an interval between metal particulates M, a diameter of the light incident to the sample contact surface F2, and the like are set to values described in the first embodiment. However, the invention is not limited thereto. That is, such values may be appropriately set if the Raman scattering light radiated from the target substance can be appropriately received and detected.

In each embodiment described above, the sample contact surface F2 is divided into 9 areas AR1 to AR9, and the partial light beams obtained by splitting the light are incident, or the light is incident to each area AR1 to AR9 in a time-division manner in order that the light from the light source device 13 is incident to each area AR1 to AR9. However, the invention is not limited thereto. That is, the number of areas where the light is incident on the sample contact surface F2 may be set to any number if it is equal to or greater than 2.

In each embodiment described above, a plurality of protrusions F21 coated by the metal particulates M are formed on the sample contact surface F2 provided in the inner surface of the substrate 3112 in the apparatus mainframes 11A to 11D side, that is, in the side where the light is incident in the sensor chip 311. However, the invention is not limited thereto. That is, a plurality of protrusions may be formed on the sample contact surface F1 formed in the inner surface of the substrate 3111.

In each embodiment described above, the cylindrical protrusions F21 coated by the metal particulates M are protruded in a grid shape on the sample contact surface F2 of the sensor chip 311. However, the invention is not limited thereto. That is, the shape and the arrangement of the protrusions may be appropriately set if an enhanced electric field capable of enhancing the Raman scattering light radiated from the target substance using the surface enhanced Raman scattering can be formed.

The entire disclosure of Japanese Patent Application No. 2011-061225, filed Mar. 18, 2011 is expressly incorporated by reference herein.

What is claimed is:

1. A measurement apparatus for measuring a concentration of a target substance contained in a sample, the measurement apparatus comprising:
a light source;
a light-incident body that has a sample contact surface, where an enhanced electric field is formed by metal particles, and enhances Raman scattering light radiated from the target substance by light emitted from the light source in the enhanced electric field;
an irradiation unit that causes the light emitted from the light source to enter into a plurality of areas in the light-incident body;
a light-receiving unit that receives the Raman scattering light radiated from a plurality of the areas; and
a quantitative measurement unit that quantitatively measures a concentration of the target substance based on a total number of the areas and a strength of the Raman scattering light received from the areas.

2. The measurement apparatus according to claim 1, further comprising a storage unit that stores the number of areas, where the Raman scattering light of the target substance is received, out of a plurality of the areas and the concentration of the target substance measured in advance depending on the number of areas in relation to each other,
wherein the quantitative measurement unit has
a count unit that counts the number of areas, where the Raman scattering light of the target substance is received by the light-receiving unit, out of a plurality of the areas, and
a concentration procurement unit that obtains the concentration of the target substance corresponding to the number of areas counted by the count unit from the storage unit.

3. The measurement apparatus according to claim 1, further comprising a storage unit that stores a total number of strengths of the Raman scattering light of the target substance received from a plurality of the areas and a concentration of the target substance corresponding to the total sum of the strengths in relation to each other,
wherein the quantitative measurement unit has
a total sum computation unit that computes a total sum of strengths of the Raman scattering light of the target substance received by the light-receiving unit from a plurality of the areas, and
a concentration procurement unit that obtains the concentration of the target substance corresponding to the computed total sum of the strengths from the storage unit.

4. The measurement apparatus according to claim 1, wherein the irradiation unit splits the light emitted from the light source into a plurality of light beams, and a plurality of the light beams are incident to each of the areas.

5. The measurement apparatus according to claim 1, wherein the irradiation unit causes the light emitted from the light source to enter into each of the areas in a time-division manner.

6. The measurement apparatus according to claim 5, wherein the irradiation unit has
a reflection unit that reflects the light emitted from the light source, and
an adjustment unit that adjusts an angle between the reflection unit and a center axis of the light emitted from the light source to cause the light reflected by the reflection unit to enter into each of the areas.

7. The measurement apparatus according to claim 5, wherein the irradiation unit has
a light-incident body movement unit that moves the light-incident body in a direction intersecting with a center axis of the light incident to the light-incident body, and
a control unit that controls the light-incident body movement unit such that the light is incident to each of the areas.

8. The measurement apparatus according to claim 5, wherein the irradiation unit has
a light source movement unit that moves the light source, and
a control unit that controls the light source movement unit such that the light emitted from the light source moved by the light source movement unit is incident to each of the areas.

9. A method of measuring a concentration of a target substance contained in a sample, the method comprising:
causing light to enter into a plurality of areas of which a total number is set in advance on a sample contact surface, where an enhanced electric field is formed by metal particles, and enhancing Raman scattering light radiated from the target substance using the light under the enhanced electric field;
receiving the Raman scattering light radiated from a plurality of the areas; and
quantitatively measuring the concentration of the target substance based on a total number of the areas and a strength of the Raman scattering light received from each of the areas.
